(19) United States
(12) Patent Application Publication
(10) Pub. No.: US 2009/0299706 A1
(43) Pub. Date: Dec. 3, 2009

(54) METHOD, DEVICE, AND PROGRAM FOR SIMULATING NANO SUBSTANCE IN ELECTRIC FIELD

(76) Inventor: Yoshiyuki Miyamoto, Tokyo (JP)

Correspondence Address: Mr. Jackson Chen, 6535 N. STATE HWY 161, IRVING, TX, 75039, US

(21) Appl. No.: 12/376,090

(22) PCT Filed: May 24, 2007
(86) PCT No.: PCT/JP2007/060646

§ 371 Date: Mar. 10, 2009

(30) Foreign Application Priority Data
Aug. 1, 2006 (JP) 2006-209766

(51) Int. Cl. G06F 17/11; G06F 17/14

(52) U.S. Cl. 703/2; 977/839

(57) ABSTRACT

The present invention provides with a method for enabling a highly accurate simulation by calculating dynamical response of electrons in the electric field without using a “fitting parameter”. According to the present invention, the method for simulating a field distribution of a nano substance in an electric field comprises the step of a Fourier transform process by virtually applying a model on which a three-dimensional periodic boundary condition is imposed to the a field distribution of a nano substance in an electric field.

Further, the method for simulating a field distribution of a nano substance in an electric field comprises the steps of arranging a virtual charge distribution on a space mesh, and evaluating a field distribution of a nano substance by calculating a potential distribution by way of Fourier-transforming a charge distribution into a reciprocal lattice space.

### TECHNICAL FIELD OF THE INVENTION

The present invention relates to a simulator technique using a computer and, more particularly, to a method, a device and a program for simulating nano substance in an electric field.

### DESCRIPTION OF THE RELATED ART

Aiming to more sufficiently describe the current technical level relating to the present invention, all of the patents, patent applications, patent publications, scientific articles and so on, which are cited or specified herein, are hereby incorporated by reference in their entirety.

As indicated in the International Technology Roadmap for Semiconductors, a next-generation semiconductor having a semiconductor gate length of 30 nm of shorter is expected to be put to practical use after 2010.

Further, researches have been actively conducted for practical application of new-generation electronic devices based on new nano substance as typified by a carbon nanotube.

Promotion of such researches strongly requires accurate prediction of the electronic property and the electric conduction in a case where a nano structure is actually in an electric field, and some advantageous effects are expected such as reduction in cost and time for trial and errors during repeated creation of a nano structure and a device-operation property.

Conventional simulation technologies for device operation were performed based on the classical Boltzmann transport equation by way of: extracting a necessary parameter from a band structure when executing a macro simulation with the simulation including dielectric constant, effective mass and relaxation time; and calculating, based on the classical electrodynamics, the field distribution relative to the assumed device structure.

In the case of Si material, improved accuracy was successfully achieved of the aforementioned effective mass approximation and relaxation time.

Non-patent Document 1: E. Runge and E. K. U. Gross, Phys. Rev. Lett. 52, 997 (1984)

Non-patent Document 2: J. Ihm, A. Zunger, and M. L. Cohen, J. Phys. C: Solid State Physics, Vol. 12, 4409 (1979) Non-patent Document: O. Sugino and Y. Miyamoto, Phys. Rev. B59, 2579 (1999); Phys. Rev. B66, 89901(E) (2002)

### DISCLOSURE OF THE INVENTION

### Problem To Be Solved By the Invention

However, the aforementioned prior arts contained the following problems.

The first problem is that since the channel length is in the nanoscale order, electronic transportation could not described by way of the classical Boltzmann transport equation.

This is because when the channel length is of nanoscale, the electronic transportation is shifted to ballistic transportation, and because accuracy could not improve unless the electronic transportation chases the real time evolution of the wave function of electrons when passing through portion of channel from the electrode.

The second problem is that the aforementioned prior arts make it difficult to accurately predict the advantageous effect of the electric field application.

This is because in the case of nano-scale substance, changes in the electronic state itself caused by electric field application cannot be ignored.

The third problem is that one cannot accurately predict the response time of electrons.

This is because the motion of electrons, when a strong electronic field is applied to a nano substance, is far from the state of equilibrium.

As could be understood from the foregoing, conventional simulators correspond to a structure of micron-order size, the operating characteristic of which is simulated by combining the classical electrodynamics with the transport equation. Besides, a “fitting parameter”, having little physical basis, is applied for prediction of the operation so that an experiment can be reproduced. Such a conventional approach is problematic when applied to nano-scale materials. This is because in the case of nanoscale material, quantum effect can be detected in electronic conduction. Further, information is required including: atomic-scale information such as a defective configuration of a channel layer, a configuration of the contact zone between a semiconductor material and an electrode; and information on change in the electronic state caused by electric field application, thus resulting in limitation of “fitting” by a parameter.

Meanwhile, ab initio calculation, effective for atomic-scale calculation, can now be applied to nacoscale material, too.

However, there is no method for calculating an electronic state under an applied field distribution in response to a nano structure, and for combining with a calculation approach in which is calculated a device operating characteristic, leading to a problem of calculation accuracy under an applied electric field.

Hence, there is a need for assuming a feasible equivalent circuit in order to conduct an operating prediction of a nanoscale material. The operating prediction of a nanoscale material can be obtained only by executing a quantum-mechanical static calculation under a condition where a parameter necessary for an equivalent circuit (contact resistance and parasitic capacitance, and so on) is uniform due to the parallel flat plate even if a state is assumed where no electric field of a nano substance is applied or even if an electric field is assumed. Accurate prediction of operation of a device is thus painstaking.

Accordingly, the present invention is created in view of the above-described problems, and the invention is intended to provide a simulation method, a system and a program that calculates the dynamical response in an electric field, and that enables accurate simulation without using a “fitting parameter” or the like.

### Means of Solving Problems

The invention disclosed in the present application substantially comprises the following configuration in order to solve the above-described problems.

The first method (system, program) of the present invention simulates a nano substance in an electric field by way of a Fourier transform process by virtually applying a model on which a three-dimensional periodic boundary condition is imposed.

The second method (system, program) of the present invention arranges a virtual charge distribution on a space mesh such that an optional field distribution is simulated.

The third method (system, program) of the present invention applies the virtual charge distribution such that an initial condition is virtually set in which electrons are bound to a position away from a substance.

The fourth method (system, program) of the present invention combines the first to third methods (systems, programs) with an approach to simultaneously simulate, by way of ab initio calculation, the dynamics of electrons and atomic nuclei in a nano substance, such that the electric conduction in the nano substance and the electron irradiation thereto are simulated.

### Advantageous Effect of the Invention

According to the present invention, the dynamical response of electrons is calculated in an electric field, and the motion of atomic nuclei can thus be solved together.

According to the present invention, in case where a device comprises, for example, nano material, the time response of electrons in an electric field is a simulation of the specific group velocity, electron-lattice scattering and electron-electron scattering, all of which the electrons themselves retain, and thus, accurate simulation can be achieved even without any “fitting parameter”.

This is because in the present invention, density distribution of electrons can be calculated based on an electronic wave function that is changing over time under an electric field by way of precise calculation according to ab initio calculation; and because a potential caused by the density distribution of electrons, a potential caused by an electric field, as well as a potential from a lattice, are all precisely introduced in the calculation.

According to the present invention, the simulation technology allows automatic introduction of the change of electronic state generated by electric field application.

This is because in the present invention, the electronic state in a nanotube, which state gradually changes in the presence of an electric field, is calculated based on the ab initio calculation and on the time-dependent density functional theory.

### BRIEF DESCRIPTION OF THE DRAWINGS

FIG. 1 is a representation of an embodiment of the present invention.

FIG. 2 is a representation of an embodiment of the present invention.

FIG. 3 is a representation of an embodiment of the present invention.

FIG. 4 is a representation of another embodiment of the present invention.

FIG. 5 is a representation of another embodiment of the present invention.

FIG. 6 is a representation of another embodiment of the present invention.

### DESCRIPTION OF NOTATIONS

1. Virtual Charge Distribution
2. Substance (Material Model)
3. Frame (Periodic Boundary of Model)
4. Cross Section of Carbon Nanotube
5. Third Electrode
6. Target Substance
7. Virtual Positive Charge
8. Electron Cloud

### BEST MODE FOR CARRYING OUT THE INVENTION

The present invention models a device structure by means of ab initio calculation according to periodic boundary condition, and optionally assumes a virtual charge distribution around a device structure, so that a uniform electric field generated by a parallel plate, as well as a spatially non-uniform electric field, can be freely produced in accordance with an assumed condition of the virtual charge density.

The present invention having such a configuration is appropriate for simulating an electric characteristics of nano material under three electrodes consisting of source, drain and gate of a FET.

In order to calculate the dynamical response of electrons, the present invention solves a time-dependent Schrödinger equation at the ab initio calculation level while the motions of atoms are classically treated reproduced, so that the effect of electric field application is directly included in the motion of electrons and atoms.

This enables real-time simulation of the electronic response in a device material, and of the interaction caused thereby between lattice and electrons.

In this way, the present invention can simulate the dynamical operating characteristic of an electronic device on the basis of a nanometer-scale material without using any arbitrary parameter.

Combination of a method for electric field calculation according to classical electrodynamics with a method for calculation of the time-dependent Schrödinger equation based on ab initio principles allows inspection of the device operation dependent on time.

Besides, the present invention, according to the similar principles, allows for dynamical simulation of structural change by electron irradiation to nano substance, and of structural displacement in a strong electric field. The present invention will be explained as follows in accordance with the Embodiments.

### EMBODIMENTS

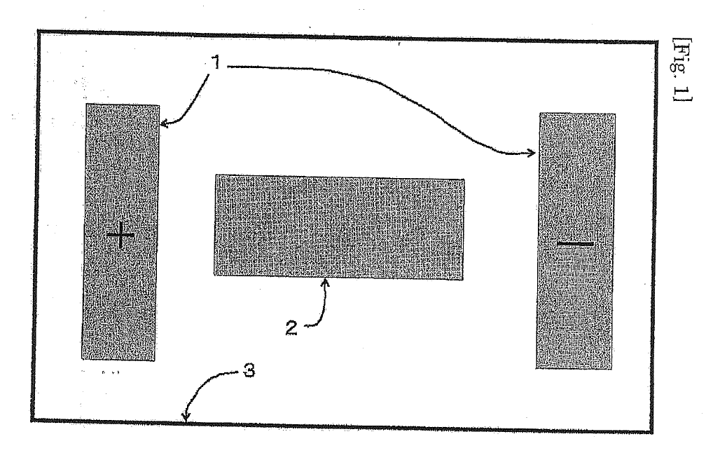

Referring to FIG. 1, the present Embodiment comprises a virtual charge distribution 1 that simulates the applied electric field, and a substance (material model) 2 that is calculated in ab initio calculation. The substance 2 contains a plurality of atoms (electrons, atomic nuclei) etc. the electronic state of which is to be analyzed (not shown).

The virtual charge distribution 1 can be optionally generated on a real-space mesh, and the charge distribution can be calculated by solving a Poisson equation. The simulation system according to the present Embodiment simulates a device either under a vacuum region condition or under a periodic boundary condition in which is assumed existence of a continuum dielectric, so that a potential distribution is calculated by way of Fourier-transforming a charge distribution into a reciprocal lattice space. The electric field strength distribution is equivalent to space derivative of the potential distribution. Meanwhile, in the present Embodiment, a Poisson equation is solved under the virtual charge distribution and the charge distribution in a substance so that a potential is evaluated. Using this potential, a plurality of wave functions relative to electrons and so on are solved so that a new electronic density is evaluated.

The substance (material model) 2 is formed in a periodic boundary similar to that of the virtual charge distribution 1. Hence, the electronic state can be calculated using a band calculation on a planar wave basis according to the Bloch theorem.

Further, the plane wave basis is also used for solving the time-dependent Schrödinger equation of electrons.

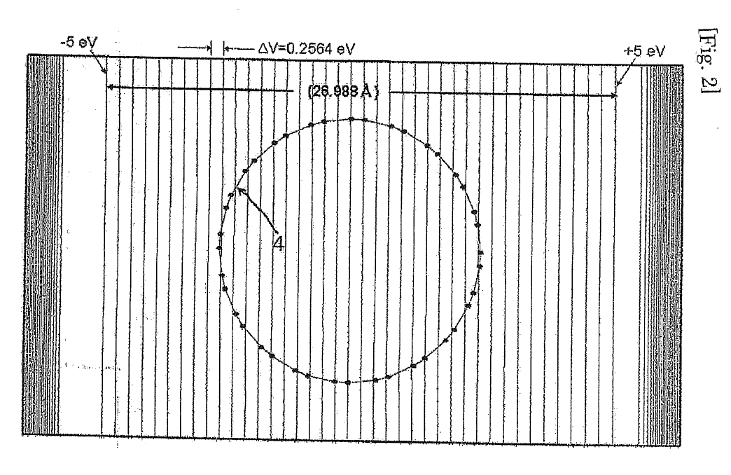

Following is a detailed explanation of the operation of the present Embodiment with reference to FIGS. 1 and 2.

In FIG. 1, the reference numeral 1 is representative of the virtual electric charge. The reference numeral 2 is representative of the substance that gives an electronic response to the electric field generated by the virtual electric charge 1. More specifically, information of the type and coordinate of each individual atom is included.

A frame 3 in FIG. 1 is representative of the periodic boundary of a model: the frame 3 is actually under a periodic boundary condition in the three-dimensional direction.

The merit of the periodic boundary condition is that the electric potential and electric field according to the virtual charge distribution 1 indicated in FIG. 1 by use of Fourier transform; and that the electronic state in the substance (material model) 2 indicated in FIG. 1 can also be calculated by use of the conventional band calculation.

Besides, under the existence condition of the virtual charge distribution 1 and the substance (material model) 2, the time evolution of electrons can be calculated according to the time-dependent density functional theory (Non-patent Document 1: E. Runge and E. K. U. Gross, Phys. Rev. Lett. 52, 997 (1984)).

In this case, the virtual charge distribution 1 and the charge distribution of electrons in the substance (material model) 2 are added, and the added charge distributions are Fourier-transformed into a reciprocal lattice space (momentum space), so that the entire energy of a system can be calculated. Further, the energy (the entire energy of a system) is differentiated with respect to atomic coordinates so that the classical force field applied to atoms can be calculated.

Accordingly, when solving the motion of electrons and atomic nuclei, the sum of potential energy of atomic nuclei (the entire energy of density functional theory (Non-patent Document 2: J. Ihm, A. Zunger, and M. L. Cohen, J. Phys. C: Solid State Physics, Vol. 12, 4409 (1979)) and the kinetic energy of atomic nuclei is conserved.

A merit of the simulation in which a periodic boundary condition is imposed is that confirmation of whether or not this law of conservation is numerically satisfied allows for easy confirmation of the calculation accuracy.

Adopting the already-published technology of calculating the time evolution of electrons (Non-patent Document 3: O. Sugino and Y. Miyamoto, Phys. Rev. B59, 2579 (1999); Phys. Rev. B66, 89901(E) (2002)), the calculation accuracy can be ensured for up to a simulation time of 1 picosecond order even when a simulation is conducted in which the motion of atomic nuclei is combined.

Following is the explanation of operation of the present Embodiment with reference to specific embodiments. FIG. 2 shows an example wherein a carbon nanotube (numerical reference 4 in the figure) is arranged in a uniform electric field generated by a parallel plate. The parallel lines represent contour lines of electric potential, where the left end is −5V (−5 eV) while the right end is +5V (+5 eV) in electric potential (electron volt). Numerical reference 4, shown as black dots arranged on a round circle, is representative of cross section of a carbon nanotube. Here, an armchair-type (10, 10) nanotube is arranged as an example.

In FIG. 2, the potential distribution at the moment when the nanotube is arranged in the electric field in the form of contour lines.

Here, in order to present a visually clear explanation of the effect of the electric field application, FIG. 2 depicts a subtraction of the potential distribution felt by electrons with no applied electric field from the electronic potential felt by electrons with applied electric field. This means that FIG. 2 depicts nothing other than the applied electric field itself.

The electric field strength is at 0.37V/angstrom, which is on the same order of the electric field strength when measured by a typical scanning tunneling electron microscope.

A contraption is provided at both ends of FIG. 2 wherein the applied electric potential reverses so that the perpendicular periodic boundary condition is met on the axis of nanotube. Such a selective contraption does not give any effect to the nanotube portion.

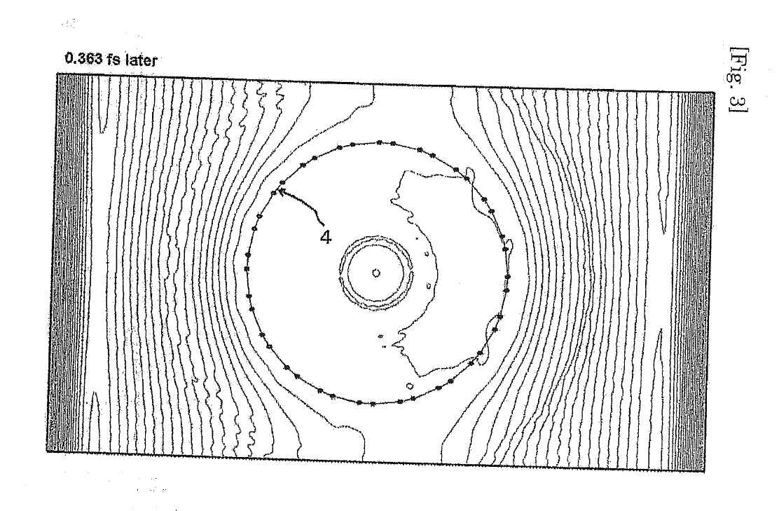

FIG. 3 is a figure that illustrates the simulation results of the dynamical response of electrons, with the results being indicated in the form of contour lines of the potential felt by electrons 0.36 fs after the state shown in FIG. 2 (1 fs=1×10-15 seconds).

Similar to FIG. 2, in order to present a visually clear explanation of the effect of the applied electric field, FIG. 3 depicts a subtraction of the electronic potential distribution felt by electrons with no electric field application from the electronic potential felt by electrons with electric field application.

The most apparent point one can see by comparing FIG. 3 from FIG. 2 is that the interval among the contour lines in the nanotube is wider in FIG. 3, which indicates that the electric field strength is significantly lower in the nanotube than outside. This is because an electron cloud of the nanotube is distorted by the Coulomb force generated by the applied potential, and because the electron cloud is thereby reorganized in such a manner that the potential of the electrons themselves will screen the applied potential.

Such screening phenomenon can be widely seen in metallic substance, and the simulation according to the present application enables calculation of the time for the screening.

This is a simulation technology effective for estimating the upper limit of the operating frequency of an element that is switched by electric field application, e.g. FET (Field Effective Transistor).

According to the present Embodiment, the dynamical response of electrons is calculated in an electric field, and the motion of atomic nuclei can thus be solved simultaneously.

In case where a device comprises, for example, nano material, the time response of electrons in an electric field is a simulation of the specific group velocity, electron-lattice scattering and electron-electron scattering, all of which electrons themselves retain, and thus, accurate simulation can be achieved even without any “fitting parameter”.

This is because in the present invention, density distribution of electrons can be calculated based on electronic wave functions that are changing over time under an electric field by way of precise calculation according to ah initio principles; and because a potential caused by the calculation, a potential due to an electric field, as well as a potential from a lattice, are all precisely introduced in the calculation.

According to the present Embodiment, change in the electronic state (electronic structure) caused by electric field application is also automatically introduced.

This is because in the present Embodiment, this calculation is based on ab initio calculation, and because the electronic states in a nanotube, gradually changing in the presence of an electric field, are calculated by time-dependent density functional theory.

Following is a detailed explanation of another Embodiment of the present invention with reference to the drawings.

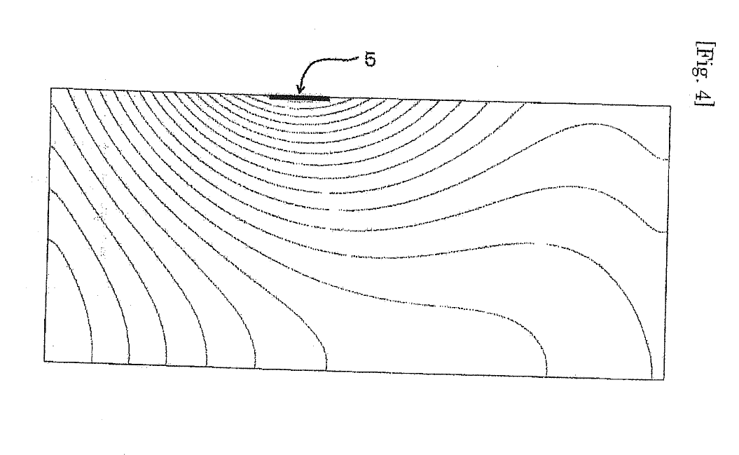

FIG. 4 indicates a uniform electric field caused by a parallel plate, as well as a field generation caused by the third electrode 5. This corresponds to a field distribution that resembles a gate electrode.

The lower part of FIG. 4 indicates change in contour lines that is the electric flux line in the right/left direction, with the figure representing the modulation of electric potential by the gate electrode provided in the upper part.

Such a calculation model can be applied to a simulation of operation of an electric field effect transistor.

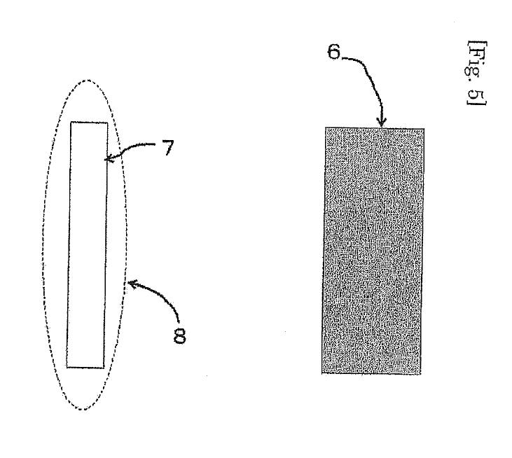

FIG. 5 schematically illustrates an electron cloud 8 bound to a positive virtual charge 7, which is arranged beside a target substance 6 at time 0.

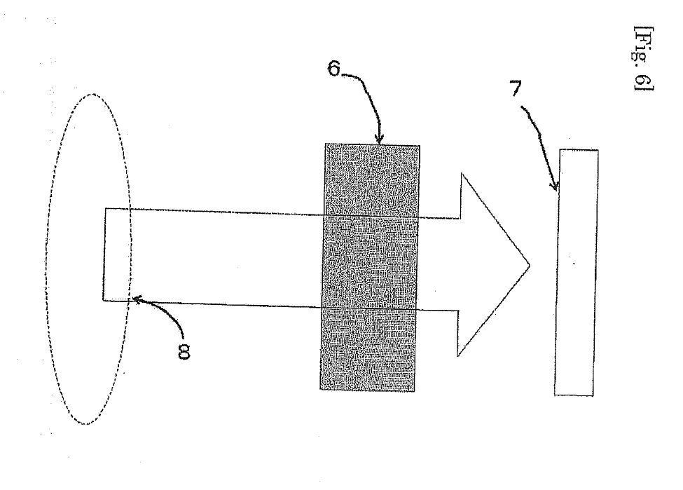

When time t>0, the virtual charge 7 is dislocated to the position shown in FIG. 6 such that a simulation is conducted in which the electron cloud 8 shown in FIG. 6 is irradiated to the target substance 6 (in a manner like the rightward block arrow). Meanwhile, dislocation of the virtual charge 7 can be readily achieved in a simulation system by change etc. of the position coordinate of the virtual charge 7. After dislocation of virtual charge 7, simulation of collision, scattering and so on is conducted by way of, for example, analyzing the dynamical response of electrons and atomic nuclei in accordance with ab initio calculation.

Each of the simulation systems according to the above-described Embodiments can be executed on an optional data processing device (computer) provided with a central processing unit (CPU), a memory device, a display device and so on (not shown). Loading a simulation program according to the present invention from the memory device of a data processing device to the main memory in the central processing unit and executing the program, the simulation results of FIGS. 2, 3 and so on will be graphically displayed (visualized) on a display device. Besides, the simulation program according to the present invention executes the following processes, for example: arranging a virtual charge distribution around a nano substance and on a space mesh; Fourier-transforming a space distribution of an electric charge into a reciprocal lattice space in a model in which a predefined periodic boundary condition is set for the nano substance and the virtual charge distribution; either evaluating an electronic state in the nano substance by way of a band calculation, or with regard to the electrons in the nano substance, evaluating the electronic state in a momentum space by solving the time-dependent Schrödinger equation; and calculating the dynamical response of electrons in the nano substance.

The present invention can be applied to anything that relates to a simulator technology using a computer and, more particularly, to a method, a device and a program for simulating nano substance in an electric field; and is not limited in terms of the possibilities of use thereof.

The invention has been described in detail with reference to certain preferred Embodiments thereof, but it will be understood that these Embodiments are intended just for describing the invention with specific examples thereof and not for limiting the invention. It should be clear that any skilled person, after reading the present specification, could make modifications or substitutions using equivalent components and technologies. However, it should also be clear that such modifications or substitutions would still be covered by the true scope and spirit of the appended Claims.

1-18. (canceled)

19. A simulation method comprising the steps of:
arranging a virtual charge distribution on a space mesh for the purpose of expressing an outer electric field to be applied to a nano substance; and
Fourier-transforming the virtual charge distribution into a reciprocal lattice space to calculate a potential distribution, to solve a self-consistent field distribution in a nano substance by use of a time-dependent Schrödinger equation, and further to evaluate the motion of atomic nuclei in the substance by use of Newton's equation of motion.

20. A simulation method comprising the steps of:
arranging a virtual charge distribution on a space mesh for the purpose of expressing an outer electric field to be applied to a nano substance; and
Fourier-transforming the charge distribution of electrons of the nano substance and the virtual charge distribution into a reciprocal lattice space to calculate a potential distribution, to solve a self-consistent field distribution in a nano substance by use of a time-dependent Schrödinger equation, and further to evaluate the motion of atomic nuclei in the substance by use of Newton's equation of motion.

21. The simulation method as claimed in claim 19, wherein the charge distribution is applied such that an initial condition is virtually set in which electrons are bound to a position away from the nano substance.

22. The simulation method wherein:
the simulation method as claimed in claim 19 is combined with a simulation method for simultaneously simulating, by way of ab initio calculation, the dynamics of electrons and atomic nuclei in the nano substance,
such that electric conduction in the nano substance is simulated, or such that behavior of the nano substance during electron irradiation thereto is simulated.

23. A simulation system comprising:
a means for arranging a virtual charge distribution on a space mesh for the purpose of expressing an outer electric field to be applied to a nano substance; and
a means for Fourier-transforming the virtual charge distribution into a reciprocal lattice space to calculate a potential distribution, to solve a self-consistent field distribution in a nano substance by use of a time-dependent Schrödinger equation, and further to evaluate the motion of atomic nuclei in the substance by use of Newton's equation of motion.

24. A simulation system comprising:
a means for arranging a virtual charge distribution on a space mesh for the purpose of expressing an outer electric field to be applied to a nano substance; and
a means for Fourier-transforming the charge distribution of electrons of the nano substance and the virtual charge distribution into a reciprocal lattice space to calculate a potential distribution, to solve a self-consistent field distribution in a nano substance by use of a time-dependent Schrödinger equation, and further to evaluate the motion of atomic nuclei in the substance by use of Newton's equation of motion.

25. The simulation system as claimed in claim 19, wherein the charge distribution is applied such that an initial condition is virtually set in which electrons are bound to a position away from the nano substance.

26. The simulation system wherein:
the simulation system as claimed in claim 23 is combined with a simulation system for simultaneously simulating, by way of ab initio calculation, the dynamics of electrons and atomic nuclei in the nano substance,
such that electric conduction in the nano substance is simulated, or
such that behavior of a nano substance during electron irradiation thereto is simulated.

27. A simulation program that executes:
a procedure for arranging a virtual charge distribution on a space mesh for the purpose of expressing an outer electric field to be applied to a nano substance; and
a procedure for Fourier-transforming the virtual charge distribution into a reciprocal lattice space to calculate a potential distribution, to solve a self-consistent field distribution in a nano substance by use of a time-dependent Schrödinger equation, and further to evaluate the motion of atomic nuclei in the substance by use of Newton's equation of motion.

28. A simulation program that executes:
a procedure for arranging a virtual charge distribution on a space mesh for the purpose of expressing an outer electric field to be applied to a nano substance; and
a procedure for Fourier-transforming the charge distribution of electrons of the nano substance and the virtual charge distribution into a reciprocal lattice space to calculate a potential distribution, to solve a self-consistent field distribution in an nano substance by use of a time-dependent Schrödinger equation, and further to evaluate the motion of atomic nuclei in the substance by use of Newton's equation of motion.

29. The simulation program as claimed in claim 27, wherein the charge distribution is applied such that an initial condition is virtually set in which electrons are bound to a position away from the nano substance.

30. The simulation program that executes:
Combination of the simulation method as claimed in claim 27 with a simulation program for simultaneously simulating, by way of ab initio calculation, the dynamic of electrons and atomic nuclei in the nano substance,
such that electric conduction in the nano substance is simulated, or
such that behavior of the nano substance during electron irradiation thereto is simulated.

31. A method for simulating a nano substance in an electric field by use of a computer, comprising the steps of:
arranging a virtual charge distribution around a nano substance on a space mesh;
Fourier-transforming a space distribution of an electric charge into a reciprocal lattice space in a model in which a predefined periodic boundary condition is set for the nano substance and the virtual charge distribution;
either evaluating an electronic state in the nano substance by way of a band calculation, or with regard to electrons in the nano substance, evaluating an electronic states in a momentum space by solving the time-dependent Schrödinger equation; and
calculating the dynamical response of electrons in the nano substance.

32. The method for simulating a field distribution of a nano substance in an electric field as claimed in claim 31, wherein a motions of atomic nuclei are classically treated such that an effect of electric field application is included in the motion of electrons and atomic nuclei.

33. The method for simulating a field distribution of a nano substance in an electric field as claimed in claim 31, comprising the step of calculating a potential distribution on the basis of the evaluated electronic state of electrons such that an electric field strength distribution is evaluated and transmitted from the potential distribution.
